(19) United States
(12) Patent Application Publication
(10) Pub. No.: US 2012/0180451 A1
(43) Pub. Date: Jul. 19, 2012

(54) Optimal Feedback Heat Energy Internal Combustion Engine And Its Applications

(76) Inventor: Hao Zhou, Panania (AU)

(21) Appl. No.: 13/498,313

(22) PCT Filed: Oct. 6, 2009
(86) PCT No.: PCT/AU09/01323

§ 371 Date: Mar. 26, 2012

(30) Foreign Application Priority Data
Jan. 10, 2009 (JP) 2009-229630

(51) Int. Cl. F02K 9/00

(52) U.S. Cl. 60/204; 60/200.1

(57) ABSTRACT

An internal combustion engine wherein a thermo potential heat flow in combustion is maximised by providing a feedback of an optimised amount of thermo potential heat flow that is modulated in the exhaust media, into the air intake, and a method of providing feedback comprises producing a shock wave of pulse of exhaust media and pulse of intake air on the opposite side of a high temperature sustainable wire screen modem thereby transferring the thermo potential heat energy flow from the exhaust media to the air intake.

### FIELD OF INVENTION

### Internal Combustion Engine

### Field of Applications

Transportation devices, including aircrafts, cars, railway locomotives and trains, marine vessels.

Related Machines and Applications.

No related internal combustion engines like the optimal feedback heat energy internal combustion engine. No transportation device powered by the optimal feedback heat energy internal combustion engine.

### BACKGROUND

The working processes of conventional internal combustion engines were invented a century ago signified by moving mechanical mechanisms intervention the working processes of conventional internal combustion engines. The moving mechanical mechanisms intervention the working processes for reciprocating engine are in the form of pistons and crankshaft. And for the jet engine for aircrafts, it is in the form of rotor and shaft. It is surprising to note that present conventional internal combustion engines follow the working processes of a century ago without significant changes. The aged old working processes still dominate over the current transportation devices powered by internal combustion engines.

There are two defects inherited from the aged old working processes of conventional internal combustion engines:

The first, under the rational criterion provided by the method developed in this patent, the overall thermo efficiency of conventional internal combustion engines is extremely low. Obviously, the extremely low thermo efficiency means excessive consumption of fuel and introduces more pollution to the environment.

The other defect of conventional internal combustion engines is that the clumsy moving mechanical mechanisms 801, FIG. 8A or 807, FIG. 8B constitute the majority of the engine assembly construction. It shows the wrong impression that the pistons and crankshaft or rotor and shaft are the icon of power of internal combustion engine. The fact is that, the power of internal combustion engine is involved in the flow of heat energy bearing by the media, the products of combustion. The method developed in this patent will prove that the nature of combustion of internal combustion engine can develop the maximum power output by its own effort without intervention of foreign moving mechanical mechanisms. On the contrary the intervening moving mechanical mechanisms consume the developed power output by the media, and restrict the full capacity of power output releasing of the media. On the past decades, manufactures of internal combustion engines devoted to sophisticate the moving mechanical mechanisms of engines and its accessories. It is the main investment of the industry, and over consumes the natural resources and human resources. Further discussions of the defects of the conventional internal combustion engines please see in [0041]. The optimal feedback heat energy internal combustion engine (hereafter “OFHE internal combustion engine) is a heat power unit. It is easy to understand after follow the embodiments of the OFHE internal combustion engine.

The defects of conventional internal combustion engines were unperceptive at the beginning of applications of the internal combustion engines on transportation devices but seems eminent and unbearable now. The conventional internal combustion engines have restricted the renovation of transportation devices.

This patent presents the OFHE internal combustion engine operated by working processes which fully develops the capacity of hidden heat energy of fuel flow and bearing effective heat energy of flow on media. The working processes of the OFHE internal combustion engine delete all the inherited defects of conventional internal combustion engines, both reciprocating engines and jet engines for aircrafts.

Reports indicate that attempts have been made to improve the performances of present transportation devices. The efforts are deemed powerless due to the defects of conventional internal combustion engines: extremely low thermo efficiency, high weight versus power output ratio, and the parts of power production and power output are bound together by bulk moving mechanical mechanisms.

### SUMMARY

The embodiments disclosed herein is the presentation of the OFHE internal combustion engine assembly in a logical scheme of analyses and syntheses.

In the embodiments, the OFHE internal combustion engine assembly is divided into two groups according to the roles of the parts of engine playing in the working processes of the engine assembly: the active group and the passive group. The active group of engine assembly includes parts of engine directly participating the production of the thermo potential heat flow TPHₘ of media. Media are the products of combustion. The passive group of assembly includes parts of engine that consumes TPHₘ and transforms TPHₘ into power output of the OFHE internal combustion engine. TPH is the shortened form of the term thermo potential heat energy flow of fluid. The refractive index m on the TPHₘ indicates the TPH carried by media. Similarly TPHₐ represents TPH carried by air.

TPH is a substantial flow of heat energy modulated on the flow of fluid. TPH has three parameters: temperature t, pressure p, and velocity v. These parameters are same in values as that of the flow of fluid on which TPH is modulated. The flow of fluid modulated with TPH has heat power production capability. In the working processes of engine, only combustion processes can produce and elevate the level of TPHₘ and modulate it on the media, the products of combustion.

In the embodiments of analyses of active group, two methods are developed for the working processes of active group.

In the embodiments, the first method provides TPHₘ^{max}. TPHₘ^{max} is very important in the development of all internal combustion engines in following aspects:

1) For any specific fuel used in internal combustion engine, there is a TPHₘ^{max} which can be determined by testing in laboratory monitoring the working processes of active group.
2) TPHₘ^{max} provides a rational criterion for thermo efficiency of all internal combustion engines as the ratio of actual power output of internal combustion engine versus TPHₘ^{max}.
3) The first method provides the guidance for the improvement of the OFHE internal combustion engines.

In the embodiments, the second method provides optimal feedback TPHₘ control system of active group.

In the embodiment, the two methods are the foundation of design and construction of the OFHE internal combustion engine.

In the embodiment, the optimal feedback TPHₘ control system of active group is developed in details by steps and accompanied with implement of contemporary technologies.

In the embodiment, the working processes of active group are analysed. There are no piston and crankshaft that of OTTO and Diesel cycles, nor the rotor and shaft that of jet engine for aircraft. There are three options of power output for the passive group. One option is the jet power output. The three parameters of jet power: p, v, t, are under control by the feedback TPHₘ control system of active group. The second option of power output of passive group is in the form of electricity. A turbo generator is adopted to the jet power to produce electricity. The third options of power output of passive group is hybrid of both jet power and electricity.

In the embodiment, the working processes of the OFHE internal combustion engine assembly are the syntheses of the working processes of active group and passive group of the engine assembly which have been analysed in [0034]-[0040]. The properties of the engine assembly are the combination of the properties of the two groups.

The design and construction procedures of the OFHE internal combustion engine assembly are the combination of the design and construction procedures of the active group and passive group.

In the embodiment of the OFHE internal combustion engine assembly, the connection between active group and passive group is a flexible duct. There is no moving mechanical mechanisms in it as that of conventional internal combustion engines. This is a favourable feature that relieve the restrictions imposed on the design of transportation devices powered by conventional internal combustion engines. The design and construction of transportation devices powered by the OFHE internal combustion engine will help to advance the transportation devices a big step forward.

In the embodiment, the applications of the OFHE internal combustion engine in the field of transportation devices are described. The applications of the OFHE internal combustion engine in the field of transportation devices are based on the following special features of the OFHE internal combustion engine.
It has no moving mechanical mechanisms 801 or 807 in FIG. 8A and FIG. 8B as that of conventional internal combustion engines.
It has overall thermo-efficiency much higher than that of conventional internal combustion engine.
It has weight/power output ratio much less than that of conventional internal combustion engines.
The OFHE internal combustion engine assembly has two groups: the active group which produces power, and the passive group which provides power output. Within the two groups there is no rigid mechanical connection. It give the designer of transportation devices to locate the power production group and power output group in favourable position separately.
There are three options of power output of passive group for selection: the jet power output, the electrical power output and hybrid of both jet power output and electrical power output.

The embodiment provides the renovation of all transportation devices powered by the OFHE internal combustion engine.

The embodiment provides the necessities of reconstruction of infrastructures to adopt the renovated transportation devices powered by the OFHE internal combustion engine to develop its beneficence.

The embodiment provides the emission of less carbon dioxide and other poison gas by the OFHE internal combustion engine than that of any comparable conventional internal combustion engines.

### BRIEF DESCRIPTION OF THE DRAWING

In the following detailed description it will be better understood by reference to the accompanying drawing. These drawings are:

FIG. 1 is a schematic representation the OFHE internal combustion engine assembly divided into two groups.

FIG. 2 is the open flow of fluid chart of active group.

FIG. 3 is the ideal feedback TPHₘ control system of active group.

FIG. 4 is a schematic representation of optimal feedback TPHₘ control system of active group.

FIG. 5A-5C are a schematic representation to compare three different feedback TPHₘ control system of active group.

FIG. 6A and FIG. 6B are schematic representation of the working process of passive group 102 of the OFHE internal combustion engine.

FIG. 7A and FIG. 7B are schematic representation of the working processes of the OFHE internal combustion engine assembly.

FIG. 8A and FIG. 8B are schematic representation of working processes of the conventional internal combustion engines.

FIG. 9 is schematic representation of general layout of the OFHE internal combustion engine assembly in the transportation devices.

### DETAILED DESCRIPTION

The OFHE internal combustion engine and its applications.

In order to describe the patent in logical scheme of analyses and syntheses, the OFHE internal combustion engine assembly is divided into two groups according to the roles of the parts of engine playing in the working processes of the engine assembly: the active group and passive group. The active group of engine assembly includes parts of engine directly participating the production of the thermo potential heat flow TPHₘ by combustion of fuel and air and modulated on media. Media are the products of combustion. The passive group of assembly includes parts of engine that consumes TPHₘ and transforms TPHₘ into power output of the OFHE internal combustion engine. [0034]-[0038] are the analyses of active groups. [0039] gives the analyses of passive group of the OFHE internal combustion engine. [0040] gives the syntheses of the two groups of the OFHE internal combustion engine assembly.

TPH is the shortened form of the term thermo potential heat energy flow of fluid. The refractive index m on the TPHₘ indicates the TPH carried by media. Similarly TPHₐ represents TPH carried by air.

TPH is a substantial flow of heat energy modulated on the flow of fluid. TPH has three parameters: temperature t, pressure p, and velocity v. These parameters are the same in values as that of the flow of fluid on which TPH is modulated and represent the thermo potential of the flow of fluid. In the working processes of engine, only combustion processes can produce and elevate the level of TPHₘ and modulate it on the media, the products of combustion.

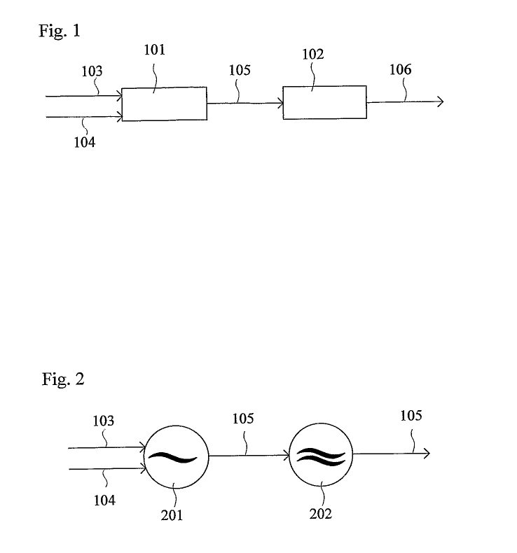

FIG. 1 is a schematic representation of the OFHE internal combustion engine assembly divided into two groups. In the sketch, 101 is the active group, 102 is the passive group, 103 is the flow of fuel intake of the active group. 104 is the flow of air intake of active group. 105 is the TPHₘ produced and elevated by active group and modulated on media, the products of combustion in active group. 106 is the power output of passive group.

The working processes of the active group.

After fuel flow and air flow induced into the combustion chamber of the active group and ignited, the combustion of fuel and air start, hidden heat energy of fuel released TPHₘ and modulate on the media, the product of the combustion. The working processes of active group consists of two dynamic systems: the combustion dynamic system and the thermo dynamic system. The combustion dynamic system produces TPHₘ, and the thermo dynamic system is bearing TPHₘ, with the product of the combustion.

FIG. 2 shows the open flow of fluid chart of the working processes of the active group 101 of FIG. 1. It is to be seen that the combustion dynamic system 201 can produce TPHₘ 105, but can not store TPHₘ 105 and the thermo dynamic system 202 can bear TPHₘ 105 but can not produce TPHₘ 105.

However, even if the hidden heat energy of fuel participating the combustion process were fully released, the combustion dynamic system of the active group in the open flow of fluid of working processes can not produce the level of TPHₘ high enough to be transformed by passive group into power output for practical application. Human efforts is needed to elevate the level of TPHₘ to be transformed into power output for engineering application. Feedback TPHₘ to flow of air to intensify the combustion dynamic system is the only measure to elevate the level of TPHₘ of active group.

The active group releases the hidden heat energy of flow of fuel participating the combustion processes of the engine into the flow of effective heat energy TPHₘ 105. The effectiveness of active group 101 depends on the mutually cooperation of the combustion dynamic system 201 and thermo dynamic system 202. The combustion dynamic system 201 produces TPHₘ 105 modulated on the media, the products of combustion processes. And the thermo dynamic system 202 manoeuvres the media bearing with TPHₘ 105 and conveys TPHₘ 105 to the passive group 102 which transforms TPHₘ 105 into power output 106.

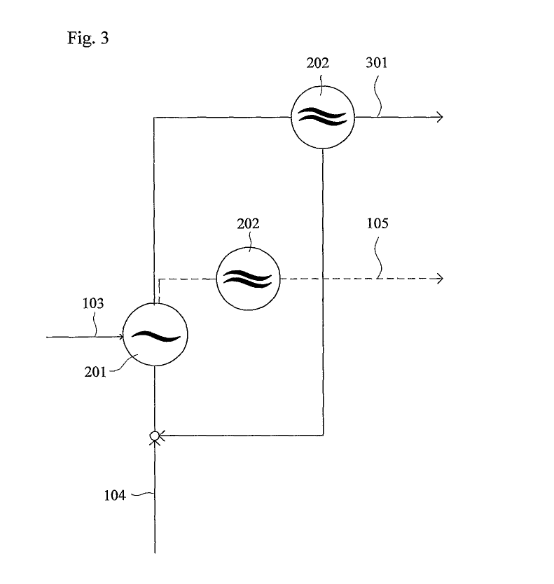

FIG. 3 is the ideal feedback TPHₘ control system of active group. TPHₘ produced by the combustion dynamic system reaches the highest level 301 and is promoted by thermo dynamic system feedback to flow of air and elevates level of TPHₐ participating combustion dynamic system. The dotted line in FIG. 3 shows the active group without feedback TPHₘ control. The level of TPHₘ 105 is much lower than 301.

The level of thermo potential heat flow TPHₘ 105 produced by combustion processes 201 of engine depends on the intensity of combustion, or rate of release of hidden heat energy, not on the fullness of releasing the hidden heat energy of fuel. Feedback TPHₘ 105 to the combustion process is to intensify the combustion processes, increasing the rate of releasing the hidden heat energy thereby elevates the level of TPHₘ 105. Two methods are developed as foundation for the design and construction of the OFHE internal combustion engine.

The First Method

The first method provides TPHₘ^{max} as follows:

The maximum thermo potential heat energy flow 301, TPHₘ^{max}, is produced in combustion dynamic system 201 only when feedback TPHₘ 105 by thermo dynamic system 202 to combustion dynamic system 201 is without loss of TPHₘ 105.

The method can be explained as follows:

Feedback TPHₘ 105 by thermo dynamic system will intensify the combustion processes up to the limit of intensity of combustion for the specific fuel participating the combustion. Any further increasing the intensity of combustion is impossible by thermo dynamic system to feedback TPHₘ 105 to combustion dynamic system. This is the states of combustion dynamic system 201 to produce TPHₘ^{max} 301.

On the other hand, the thermo dynamic system 202 can not carry TPHₘ 105 greater than that produced by combustion dynamic system and feedback TPHₘ 105 to the combustion dynamic system 201. Both dynamic systems 201 and 202 can maintain on TPHₘ^{max} 301 only when feedback TPHₘ 105 by thermo dynamic system 202 to combustion dynamic system 201 is without loss of TPHₘ 105 as stated by the method.

The method can also be verified by testing.

The method of provides TPHₘ^{max} 301 is important in the development of OFHE internal combustion engines in following aspects:

1) The method implies that with right fuel/air ratio, TPHₘ^{max} produced by combustion dynamic system depends on the fuel used in the OFHE internal combustion engine. For any specific fuel used for the OFHE engine, TPHₘ^{max} can be determined by testing in laboratory monitoring the working processes of active group.
2) The method provides a rational criterion for thermo efficiency of internal combustion engines as

$$η = \frac{Power output of engine}{{TPH}_{m}^{max} , 301}$$

This is the main guide for the design of the OFHE internal combustion engine.

So far the thermo-efficiency of internal combustion in text books is overestimated. The thermo-efficiency of conventional internal combustion engines according to the rational criterion is extremely low.

3) The method pointed out that the intervention of moving mechanical mechanisms in the working processes of conventional internal combustion engines is the main cause of lower the thermo efficiency of conventional internal combustion engines:
a) the feedback TPHₘ to combustion dynamic system is degraded twice: The TPHₘ first changes into mechanical power and mechanical power changes into TPHₘ again and feedback to combustion dynamic system;
b) the combustion dynamic system is working always under devalued TPHₘ which has been produced by combustion dynamic system;
c) the intervention of moving mechanical mechanisms of conventional internal combustion engines in the working processes makes the engine to produce much less TPHₘ^{max} of the specific fuel.

These defects of conventional internal combustion engines can not be rectified within the frame of conventional internal combustion engine.

Standard text books about internal combustion engines are the exposition of conventional internal combustion engines. It includes no idea of TPHₘ^{max}. The inventors of internal conventional engines a century ago probably were unaware the necessity of feedback control TPHₘ in the engine working processes. Yet the inventors had unconsciously involved mechanical mechanism in their engines to provide feedback TPHₘ processes. However, the moving mechanical mechanisms intervening the feedback processes of TPHₘ are against the method of provides TPHₘ^{max} stated above. It consume TPHₘ produced by combustion, and suppress the combustion processes to produce TPHₘ to its maximum extent. This is the origin of serious drawback of conventional internal combustion engines. Further discussion of the defects of conventional engines will be given in [0041].

In practice, there are some losses of TPHₘ in the feedback TPHₘ control cycles of the OFHE internal combustion engine. The feedback TPHₘ control system of the OFHE internal combustion engine ensures the optimal TPHₘ in all internal combustion engines. The method of optimum of feedback TPHₘ control system of the OFHE internal combustion engine and technologies implementing the method will be developed in [0037].

The Second Method

Feedback TPHₘ Control System of Active Group and the Optimal Feedback TPHₘ of Active Group.

One of the most important contributions of the OFHE internal combustion engine is the development of the method of optimal feedback TPHₘ control system of the active group and its implementation with the contemporary technologies.

General automatic feedback control systems are controlling the parametric objective of dynamic system beyond the energy sources of the systems. The tasks of feedback control of the OFHE internal combustion engine are to control the energy source of combustion dynamic system as well as the parameters of thermo dynamic system of the OFHE internal combustion engine.

### The Second Method:

Feedback TPHₘ control system of the active group 101 is optimized by demodulation TPHₘ from media, products of combustion, and modulated TPH on the fresh air participating the combustion dynamic system. The optimum feedback TPHₘ processes elevate the level of

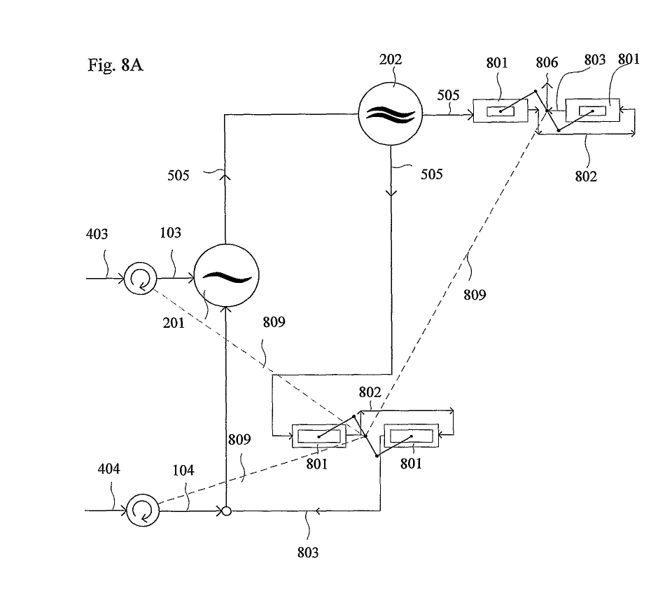

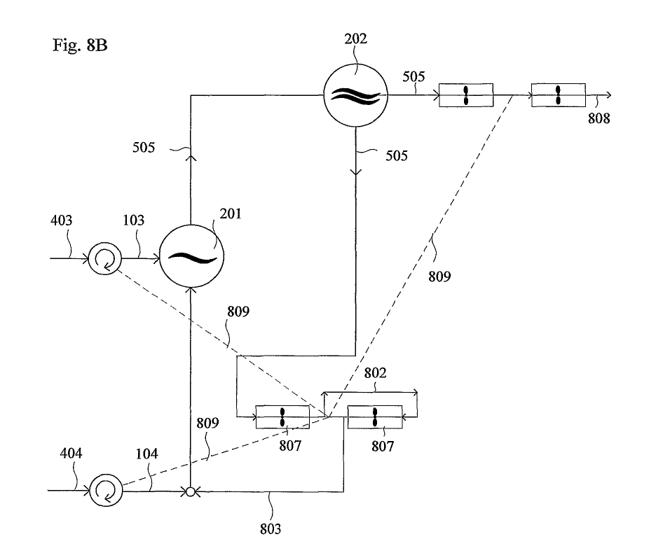

TPHₘ produced by combustion dynamic system approaching TPHₘ^{max}. The feedback TPHₘ processes are of self sufficiency, it needs no assistance of foreign moving mechanical mechanisms 801 of FIG. 8A, nor the assistance of foreign moving mechanical mechanisms of rotor and shaft of jet engine for aircraft, 807 of FIG. 8B.

The demodulation from media and modulated TPH on fresh air are carried out by conducting shock wave between media and fresh air participating the combustion dynamic system.

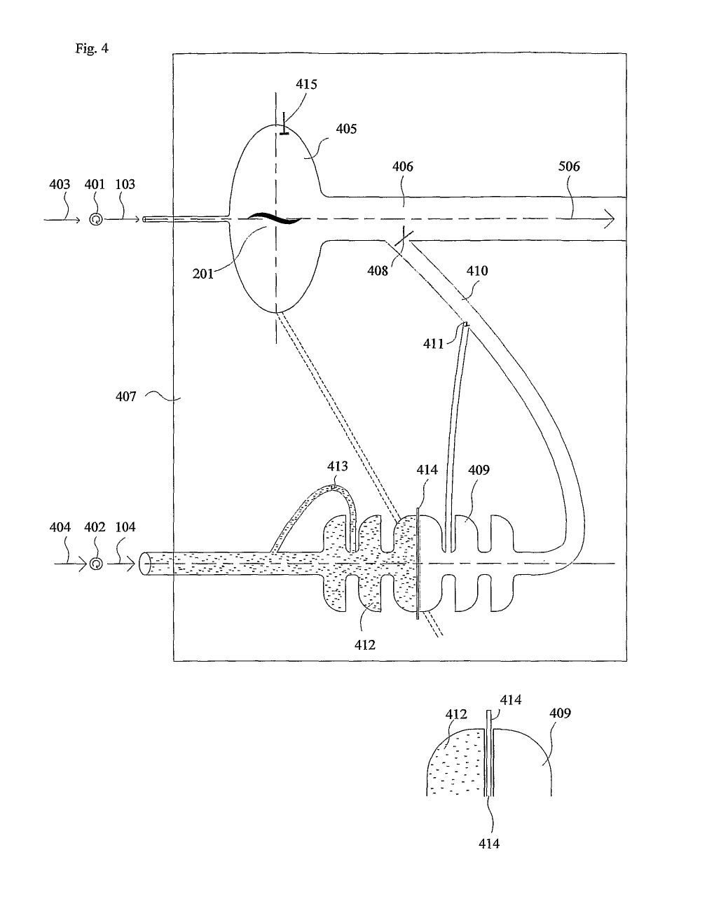

FIG. 4 is a schematic representation of optimal feedback TPHₘ control system of active group 101 to illustrate the design and construction of the feedback system. The working processes are explained as follows.

1) In the active group, the flow of fuel 103 and flow of air 104 are independently driven by pumps 401 and 402 from fuel source 403 and air source 404 respectively into the combustion chamber 405. The intake fuel and air are regulated separately.
2) After flow of fuel 103 and flow of air 104 are conducted into combined combustion chamber 405, spark plug 415 sends a spark to start the combustion, since the working processes of active group are uniflow, once the combustion process started, no spark is needed till next starting operation.
3) The combustion dynamic system 201 produces TPHₘ 506 and modulated on media, the products of combustion, and sends to passive group for power output, through duct 406, which is engraved in stationary stand 407 of active group 101.
4) Valve v₁ 408 is provided to guide part of TPHₘ 506 modulated on media feedback to a media pulses formate duct 409 through feedback duct 410. Both feedback media pluses formate duct 409 and feedback duct 410 are engraved in the interior of the stationary stand 407 of active group 101 structure.

The number of corrugated media pulse formate and shape of corrugation depend on the volume of media produced in combustion chamber.

5) The shape of feedback media pulses are therefore fixed.
6) Valve v₂ 411 is provided to guide part of TPHₘ 506 in the feedback duct 410 and injected at the last valley of the pulse formate duct 409. The jet of TPHₘ 506 is used to regulated p₂ of the front of last media pulse.
7) Similar formate air pulse duct 412 is placed at opposite side of the TPHₘ modem
8) Independent and regulated air is supplied to the formate air pulse duct 412 as step 6) to produce fixed air pulse in the formate air pulse duct 412 as step 5) for TPHₘ 506 media pulses, but no valve as v₁ of step 4).
9) Valve v₃ 413 is provided as that of step 6) to regulate p₁ of the front of last air pulse as that for TPHₘ 506 of step 6).
10) The media pulse front of TPHₘ 506 of step 6) and the air pulse front 412 are induced to the opposite side of TPII, modem 414 using a synchronizer. The synchronizer senses and controls the parameters p₁ and p₂ of front of air pulse and media pulse respectively at equal value by valves v₃ and v₂ and to meet on the opposite side of TPHₘ modem 414.
11) A shock wave between TPHₘ in 506 media pulse and air pulse produces at the TPHₘ modem 414 and TPHₘ 506 is demodulated from media and modulized on the air.
12) The demodulated media are exit through a valve v₄ (not shown in the figure) and the modulized air is passed to the combustion chamber 405 through a valve v₅ (not shown in the FIG.
13) One cycle of feedback TPHₘ control system of active group 101 is completed and continues the cycles successively.
14) The duct 406, 410, 409 and 412 may be made of by other high temperature sustainable rigid materials and inserted in the stationary stand of active group 407.

In the working processes of feedback TPHₘ, all the valves, synchronizer and the timing of shock wave between media pulse and air pulse occurred at the TPHₘ modem are coordinated and controlled by computer.

The feedback TPHₘ processes of the active group are operated by TPHₘ of the processes itself without piston and crankshaft that of OTTO and Diesel working processes or rotor and shaft that of jet engine for aircraft.

In FIG. 4, 414 is an enlarged view of pulse formate duct 409 and 412 at the opposite side of TPHₘ in modem 414. It is to be noted that 409 and 412 closing but not touching TPHₘ modem. The seat of 414, formates 409 and 412, and valves v4 and v5 form a closed chamber for the processes of demodulation of TPHₘ from media and modulated to air. After the processes of demodulation of media, and modulation of air, the valve v5 open to exit media and valve v4 opens to transfer high temperature air to combustion chamber 405.

All the above operations are under normal working condition after starting operation. For the starting operation stater should be used.

It is to be note that FIG. 4 is used to illustrate the principle of design and construction of optimal feedback TPH, control system, final design should be made in detail design and construction.

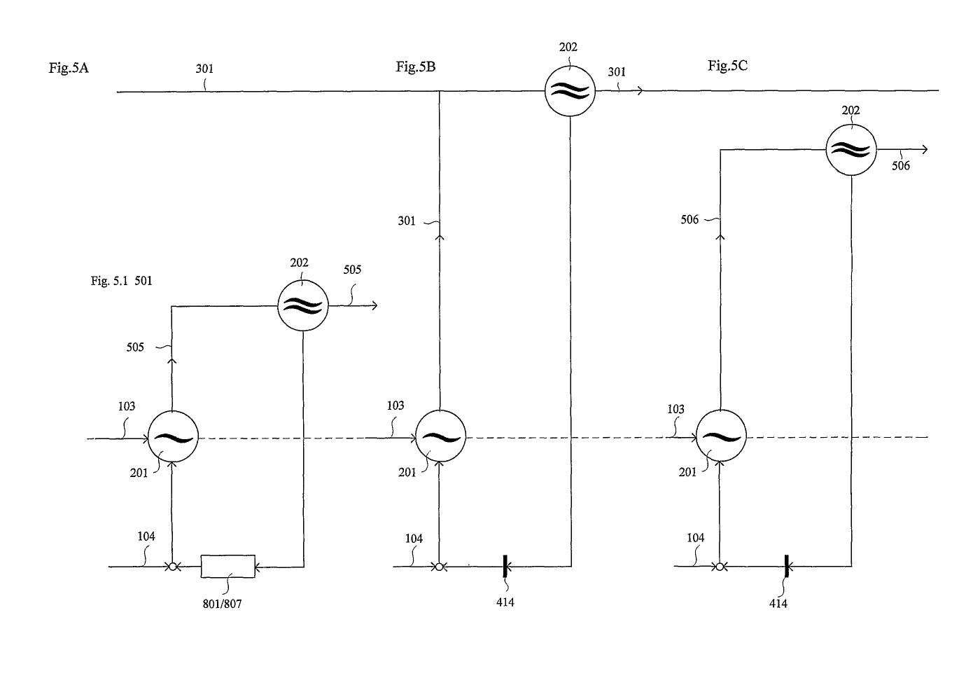

FIG. 5A-5C are a schematic representation to compare three different feedback TPH control system of active group.

FIG. 5A shows the moving mechanical mechanisms 801 or 807 intervening the working processes of feedback TPHₘ control system of active group, TPHₘ 505<<TPHₘ^{max} 301.

FIG. 5B shows the ideal TPHₘ modem 506 is used in the working processes of feedback TPHₘ control system of active group. TPHₘ produced by combustion dynamic system 201 produce TPHₘ^{max} 301.

FIG. 5C shows the real TPHₘ in modem 414 is used in the working processes of feedback TPHₘ control system of active group. TPHₘ produced by combustion dynamic system 201 produces TPHₘ 506≦TPHₘ^{max} 301.

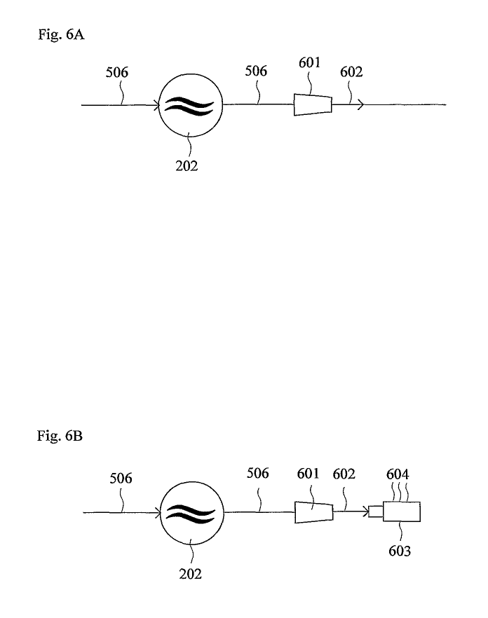

FIG. 6A and FIG. 6B are schematic representation of the working processes of passive group 102 of the OFHE internal combustion engine. There is no moving mechanical mechanisms such as 801 or 807 of FIG. 8A and FIG. 8B intervening the working processes of the passive group as that of conventional internal combustion engines. Three options are provided for the power out for the passive group:

The first option is the jet power output 602 as shown in FIG. 6A. The TPHₘ 506 produced by combustion dynamic system 201 in active group 101 is conducted into a jet construction 601 through thermo dynamic system 202 and forms the jet power output 602. The three parameters of jet power output: temperature t, pressure p, and velocity v, are under control of feedback TPHₘ control system of active group shown in FIG. 4.

The second option is shown in FIG. 6B, the jet power output 602, is adopted by the turbo-generator 603 to send out electricity 604 as power output.

The third option is the hybrid of both jet power output and electrical power output.

The working processes of the OFHE internal combustion engine assembly are the syntheses of the working processes of the active group and the passive group of the engine assembly which have been analysed in previously [0034]-[0039]. The properties of the engine assembly are the combination of the properties of the two groups.

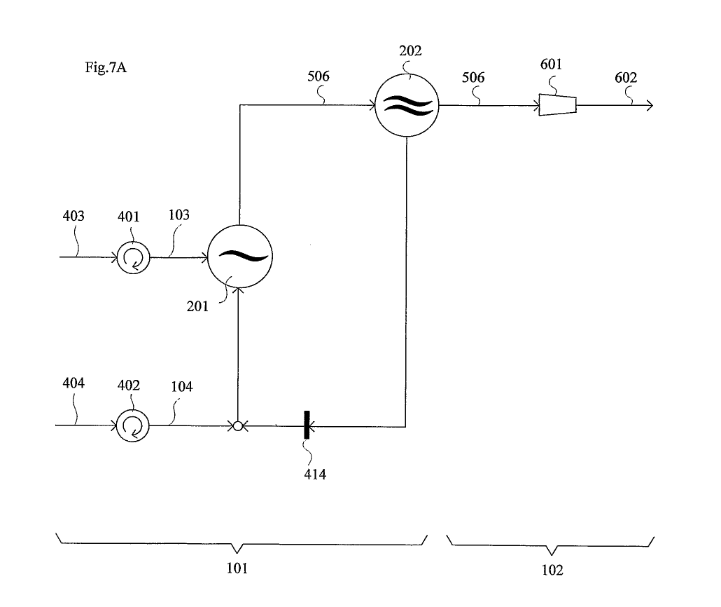

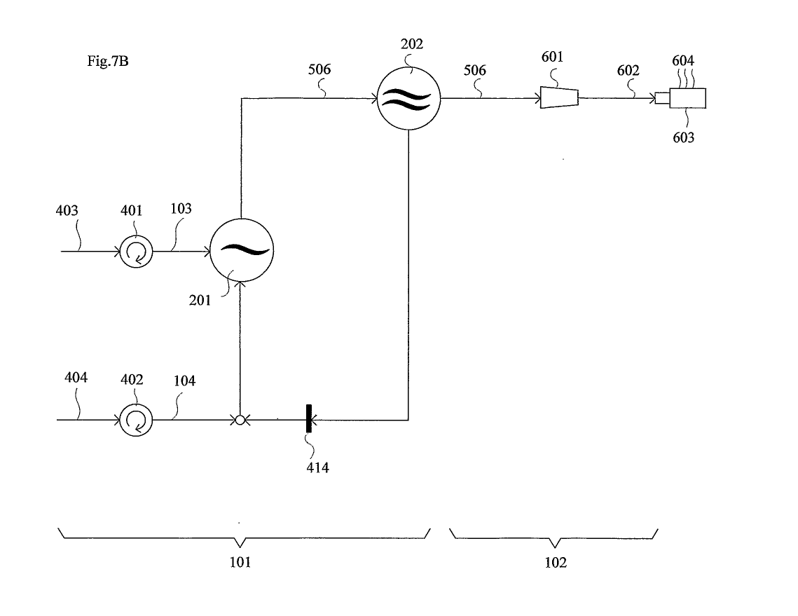

FIG. 7A and FIG. 7B are schematic representation of working processes of the OFHE internal combustion engine assembly. The flow of fuel 103 and flow of air 104 are conducted to the active group 101 by independent power driver 401 and 402 respectively from fuel source 403 and air source 404. The combustion dynamic system of active group 201 produces TPHₘ 506 which is carried out by thermo dynamic system 202 to the passive group 102. Part of TPHₘ 506 of thermo dynamic system 202 is feedback to combustion dynamic system through the modem 414. The passive group is a jet construction 601. The power output of passive group has three options: One option is the jet power output 602 in FIG. 7A. The other option is electrical power output 604, where the turbo generator 603 is adapted to the jet 602 in FIG. 7B. The third option is hybrid of both jet power output and electrical power output. Particular feature of the OFHE internal combustion engine assembly are:

1) The OFHE internal combustion engine assembly has no mechanical connections between its active group and passive group; each group has its distinctive working processes.
2) The OFHE internal combustion engine is distinguished by its optimal feedback TPHₘ control system processes in the active group. The processes are completed by its own energy.
3) The overall thermo efficiency of the OFHE internal combustion engine is optimal based on the method of optimal feedback TPHₘ control system of the active group.
4) Independent power drivers to supply fuel and air to the engine proper.

Defects of the Conventional Internal Combustion Engines.

The nature of the active group and two methods developed in [0036] and [0037] are applicable to all internal combustion engines. The conventional internal combustion engines assembly can also be divided into the active group and the passive group. The working processes of the conventional internal combustion can be analysed in FIG. 8A and FIG. 8B.

### Defects of the Conventional Internal Combustion Engines are Clear:

1) FIG. 8A shows the sketch of working processes of reciprocating cycle conventional engines, i.e. the Otto cycle and Diesel cycle engines. The engines have the moving mechanisms of pistons and crankshafts showing in FIG. 8A as 801. In order to show the change in the form of flow of power, the piston cylinder and crankshaft mechanisms are presented in double form. It is to be noted that after TPHₘ 505 entering the moving mechanisms 801, the heat energy flow TPHₘ 505 is changing into mechanical power 802. This is so called power stroke. And the mechanical power 802 is entering the same moving mechanical mechanisms 801 again and changing into heat power flow 803, and feedback to the combustion dynamic system 201. This is so called compression stroke. The feedback TPHₘ 505 in conventional internal combustion engines is devalued twice, the power output is 806.

The working processes of jet engines for aircrafts are the same as that of conventional reciprocating engines. It is shown in the FIG. 8B similar to FIG. 8A. The moving mechanical mechanisms intervening the working processes are rotor and shaft 807, and the power output is the jet power 808. The feedback TPHₘ 505 is similarly devalued twice. In both reciprocating engines and jet engines, the active group of power production and the passive group of power output are rigidly bound up by moving mechanical mechanisms shown by dotted lines 809.

2) The clumsy moving mechanical mechanisms 801, FIG. 8A or 807, FIG. 8B extend to the whole engine from fuel and air intake driving to the output power driving shown by dotted lines 809. TPHₘ in the long range transmission will be lost, thereby the level of TPHₘ that could be used as power output is reduced.
3) The fuel and air intake driving mechanism and output power driving mechanism are all shared with the same piston and crankshaft or rotor and shaft. The power production part and all power consumer parts are bound together as shown by the dotted lines 809. It greatly limited the design of transportation devices and its performances.
4) In the manufactory of the conventional internal combustion engines the mechanical works are mostly the said piston and crankshaft or rotor and shaft moving mechanical mechanisms of the engines. Maintenance works of the transportation devices are also the same mechanisms. All the costs are much greater than the counter works of the OFHE internal combustion engine.

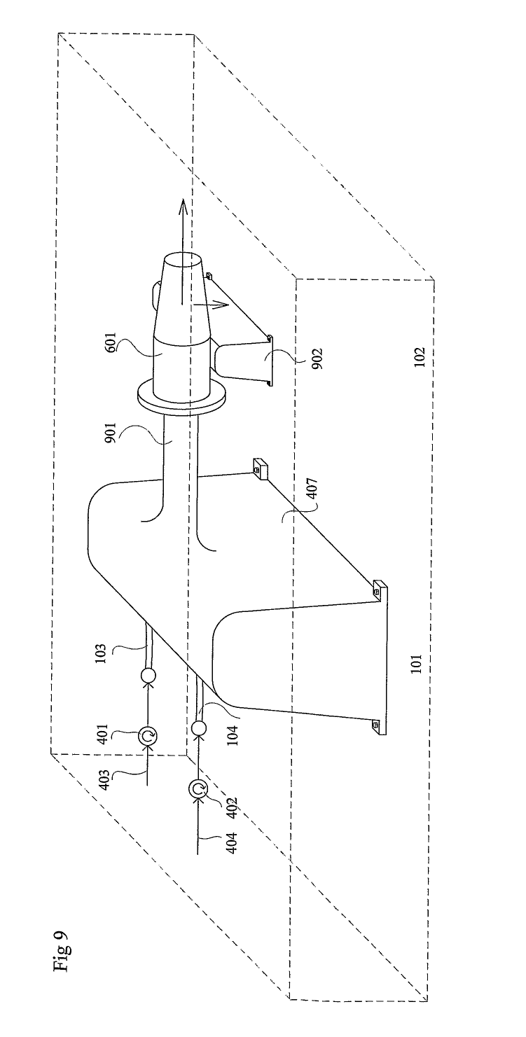

FIG. 9 is schematic representation of the OFHE internal combustion engine assembly in the transportation devices. The independent fuel 103 supply tubes and independent air supply tube 104 are the input of the stationary stand of active group 407. The duct 901 of TPHₘ modulated on media is the output of the stationary stand of active group 407 which is mounted on the transportation devices on favourable position.

Jet power output 601 is mounted on a vertically rotating mechanism and the later is mounted on the stationary stand of passive group 902. The stationary stand of passive group is mounted on favourable position of the transportation devices separately from the stationary stand of active group

The vertically rotating mechanism bearing with the power output jet 601 are operated in coordinating with parts of the transportation devices (such as changing and folding wings of aircraft) by power operated linkage to control the posture of the transportation devices (such as landing and take off operation of aircrafts).

The coordination of posture of transportation device and direction of jet power output are controlled by computer.

The stationary stand of active group and stationary stand of passive group are connected by the duct of TPHₘ modulated on the media. There are no moving mechanical mechanisms or other rigid material in the duct. Both stationary stands can be fixed on the transportation devices independently.

FIG. 9 is the general layout of OFHE internal combustion engine assembly. Detailed design of stationary stand of active group 407, stationary stand of passive group 902, the vertically moving mechanisms of jet power output and linkages with posture of transportation devices are all general mechanical design work.

The design and construction of the active group are the realization of the optimal feedback control system of FIG. 4. The fundamental differences between the OFHE internal combustion engine and the conventional internal combustion engines are that the OFHE internal combustion engine depends on the operation of system of valves, synchronizers and TPHₘ modem to control the feedback TPHₘ control system, while the conventional internal combustion engines use moving mechanical mechanisms to do the feedback TPHₘ. The defects of conventional engines have been analysed previously, especially in [0041].

The operation of feedback TPHₘ control system are valves, synchronizers and TPHₘ modem which may be relocated in detail design. The operation of valves and synchronizer and its peripherals may be mechanical, electrical or fluidic system and devices.

As stated [0037] step 14, all the valves and synchronizer are coordinated and controlled by computer to ensure the shock wave occurs at TPHₘ modem to transmit TPHₘ from media to air and participating combustion processes.

TPHₘ modem subassembly is important part of the OFHE internal combustion engine assembly block. The functions and working principles have been explained in [0037]. The subassembly includes the TPHₘ modem proper and peripherals. The TPHₘ modem proper is thin nets fabricated by fine wires. In the working process of the engine, nets are under pressure and high temperature of the shock waves, no tensile stress is induced in the material of the nets. The market available anticorrosion and high temperature sustainable materials can work, probably it doesn't last long time. It is believable that special material for the nets can be developed with the contemporary material technologies. The TPHₘ modem proper should be easy replaceable in the TPHₘ modem subassembly like the spark plug of conventional engines. The peripherals are attached to the modem proper to conduct the processes of demodulation of TPHₘ from media and modulated it on the flows of air participating the combustion as stated in [0037].

Main pieces of the peripherals include synchronizer and fluidic valves. Technologies of fluidic circuit design are applicable to the design of TPHₘ modem subassembly. All parts of the TPHₘ modem subassembly and the OFHE internal combustion engine assembly are under higher temperature than that of conventional internal combustion engines, since the combustion temperature and temperature of flow of media are higher than that of the counterparts of conventional internal combustion engines.

Applications of New Engine.

1) The essential features of the OFHE internal combustion engine are
It has no piston and crankshaft as that of Otto and Diesel cycles;
No rotor and shaft as that of jet engine for aircraft.
It has overall thermo-efficiency much high than the conventional internal combustion engines.
It has weight/power output ratio much less than the conventional internal combustion engines.
The OFHE internal combustion engine assembly has two groups: the active group which produces power, and the passive group which provides power output. Within the two groups there is no rigid mechanical connection. It give the designer of transportation devices to locate the power production group and power output group in favourable position separately.
   2) Transportation devices powered by the OFHE internal combustion engine will be renovated transportation facilities with better performances, safety and conveniences.
   3) The aircraft powered by the new engine will have changing and folding wings, thereby the landing and take off of aircraft can be operated without long running way. The speed of flight in sky can be much high than the present aircraft. It is impossible for the aircraft powered by the conventional internal combustion engines.
   4) The cars powered by the OFHE internal combustion engine can be carried with a small folding wing and lifted and served as amphibian car. It is impossible for the present car to do the same task.
   5) The locomotive of the railway power by the OFHE internal combustion engine will have much higher speed than the present train speed. And the air floating train can be design to replace the magnetic floating train currently operated. The air floating train is safer than the magnetic floating train. It is impossible for the train powered by the conventional internal combustion engine to do the same.
   6) The marine vessels powered by the OFHE internal combustion engine will be manoeuvred at much better performances.
   7) In order to fully develop the capability of distinguish performances of transportation devices powered by the new generation engine than that of transportation devices powered by the conventional internal combustion engines, correspondent facilities should be provided to accommodate the transportation devices powered by the OFHE internal combustion engine. The infrastructure of airport, railway and railway station, the car traffic and wharf should be renovated.
   8) The construction of OFHE internal combustion engine are simple, reliable, and low in weight/power output rate. Manufacture industries related with engine and transportation devices will be set in track of sustainable development.
   9) The OFHE internal combustion engine and transportation devices powered by the OFHE internal combustion engine emit less carbon dioxide and other exhaust gas than similar power of conventional internal combustion engines. Therefore it meets the green car requirements.
   10) The OFHE internal combustion engine will initiate new generation transportation devices and related manufacture industries.

The claims defining the invention are as follows:

1) An optimal feedback heat energy internal combustion engine having working processes based on two methods developed in this patent comprising
The first method providing the maximum thermo potential heat flow TPHₘ^{max}
wherein the said engine tending to approach TPHₘ^{max} production in combustion. The second method providing optimal feedback thermo potential heat energy flow, wherein the said engine producing higher power output than any comparable conventional internal combustion engine.

2) The engine assembly of engine of claim 1) comprising two structural groups:
the active group producing the thermo potential heat flow;
the passive group transforming the thermo potential heat flow produced in the active group into power output of the said engine.

3) The working processes of active group of claim 2) comprising two mutually cooperative dynamic systems: the combustion dynamic system and thermo dynamic system; wherein the combustion dynamic system producing thermo potential heat energy flow, TPHₘ, modulated on media, the products of combustion; and the thermo dynamic system manoeuvre the TPHₘ only; and wherein TPH is the shortened for the term thermo potential heat flow modulated on fluid flow with three parameters temperature t, pressure p and velocity v, which are same in value as that of flow of fluid on which TPH modulated; and wherein the refractive index m on TPHₘ indicating TPH carried by media, similarly the refractive index a on TPHₐ indicating TPH carried by air.

4) According to claim 3) developed two methods as foundation of design and construction of the engines of claim 1) comprising the first method as follows:
“The maximum thermo potential heat energy flow, TPHₘ^{max}, is produced by combustion dynamic system with feedback TPHₘ 105 to combustion dynamic system 201 without loss of TPHₘ 105.”
and the second method as follows:
“Feedback TPHₘ control system of the active group 101 is optimized by demodulation TPHₘ from media, products of combustion, and modulated TPH on the fresh air participating the combustion dynamic system. The optimum feedback TPHₘ processes elevate the level of TRHₘ produced by combustion dynamic system approaching TPHₘ^{max}. The feedback TPHₘ processes are of self sufficiency, it needs no assistant of piston and crankshaft that of Otto and Diesel cycles 801 of FIG. 8A, nor the assistance of rotor and shaft 807 of FIG. 8B of jet engine for aircraft.
The demodulation TPHₘ from media and modulated TPH on fresh air are carried out by conducting shock wave between media and fresh air participating the combustion dynamic system.”

5) The first method of claim 4) comprising following important aspects:
a. The method implies that with right fuel/air ratio TPHₘ^{max} produced by combustion dynamic system depends on the fuel used in OFHE internal combustion engine. For any specific fuel used for the OFHE internal combustion engine TPHₘ^{max} in can be determined by testing in laboratory monitoring the working processes of active group.
b. The method provides a rational criterion for thermo efficiency of internal combustion engines as
$$η = \frac{Power output of engine}{{TPH}_{m}^{max} , 301}$$
This is the main guide for the design of engine claim 1).

6) The second method of claim 4) being physically illustrated by FIG. 4.

7) The applications of engine claim 1) in transportation devices being illustrated in FIG. 9.

8) The engine of claim 1) comprising three structural systems:
the structure of the ducts of intake and output system of combustion chamber;
the structure of the control system of feedback TPHₘ to combustion chamber;
the structure of the system of producing shock wave to transfer TPHₘ from media to fresh air.

9) According claims 8) developed intake and output ducts of the active group comprising:
combustion chamber;
duct of output connected with combustion chamber;
ducts forming TPHₘ pulses and air pulses connected to the combustion chamber;
all the ducts engraved on the interior of stationary stand 407 of FIG. 9, or made by high temperature sustainable materials and inserted in the interior of stationary stand of active group.

10) According to claims 8) developed the control system of feedback TPHₘ to combustion chamber comprising valves to guide the flow of TPHₘ pulses and air pulses.

11) According to claims 8) developed system of producing shock wave to transfer TPHₘ from media to fresh air comprising:
TPHₘ modem proper fabricated by high temperature sustainable wire screen;
the peripheral synchronizer sensing the pressures of front of last pulse of media and air, and synchronizing both pulses to the opposite side of TPHₘ modem, thereby producing shock wave between pulse of media and pulse of air to transfer TPHₘ of media to air.

12) According to claims 7) developed the general layout of engine of claim 1) in transportation devices FIG. 9 comprising:
the stationary stand of active group 407 mounted on the transportation devices on favourable position;
the stationary stand of passive group 902 mounted on the transportation devices on favourable position separately from the stationary stand of active group 407;
the stationary stand of passive group 902 providing the vertically rotating mechanisms bearing with the power output jet structure 601 linked with part of transportation device by power operated mechanism thereby the vertical movement of jet power output coordinate with the posture of transportation device;
the output duct of stationary stand of active group 407 connected with input duct of stationary stand of passive group with flexible duct 901 of FIG. 9.

13) According to claims 2)-12) the essential features of the engine claim 1) comprising:
high thermo efficiency;
low weight/power output ratio;
independent power production unit and power output unit.

14) According to claims 1)-13) developed aircraft comprising changing and folding wings thereby the landing and take off of aircraft operated vertically and flying in sky operated with posture aerodynamically to suit high speed flight.

15) According to claim 14) infrastructures of airport adopt to renovated aircraft.

16) According to claims 1)-13) developed car comprising small folding wing; with hybrid power in form of jet and electrical; thereby the cars becoming amphibian car.

17) According to claim 16) infrastructure of road adopt to renovated car.

18) According claims 1)-13) developed locomotive and train comprising air floating trains thereby operating at much high speed and safety in environment.

19) According to claim 18) infrastructures of railway adopt to renovated locomotive and train.

20) According to claims 1)-13) developed marine vessels comprising better performance in manoeuvre than present marine vessels.

21) According to claims 20) infrastructures of wharf adopt to renovated marine vessels.

22) According to claims 1)-13) movements coordinate by computer comprising:
the movement of all valves,
the peripheral synchronizer of media pulse and air pulse, thereby approaching at the opposite side of TPHₘ modem simultaneously to produce shock wave to transfer TPHₘ of media to fresh air;
the movement of jet power output to coordinate with the posture of transportation device.

23) According to claims 1)-13) transportation devices powered by engine claim 1) comprising emission less carbon dioxide and other exhaust gas than transportation devices powered by conventional internal combustion engines.
